(19) United States
(12) Patent Application Publication
(10) Pub. No.: US 2015/0206177 A1
(43) Pub. Date: Jul. 23, 2015

(54) USING CONTENT SELECTION URLS

(71) Applicant: Google Inc., Mountain View, CA (US)

(72) Inventors: Karen Chialin Yao, Los Altos, CA (US); Rahmi Marasli, Mars, PA (US); Gaurav Bhaya, Sunnyvale, CA (US); Vinod Ramachandran Marur, Palo Alto, CA (US)

(73) Assignee: Google Inc., Mountain View, CA (US)

(21) Appl. No.: 14/057,421

(22) Filed: Oct. 18, 2013

(51) Int. Cl. G06Q 30/02

(52) U.S. Cl. CPC G06Q 30/0246

(57) ABSTRACT

Click-through and/or landing page universal resource locators (URLs) may be received by a computing device, such as a content selection service. A click-through URL template may also be defined and associated with a node of a hierarchy that represents an account of a content provider. The template may be used to update a click-through URL associated with a piece of content from the provider.

### BACKGROUND

A content selection service may allow one content provider to provide its content in conjunction with that of another content provider. For example, a content selection service may allow an advertiser to place an advertisement on a particular webpage. In some cases, content placed by a content selection service may be interactive. For example, a placed advertisement may cause a device to be redirected to the website of the advertiser, if the user of the device clicks on the advertisement. To facilitate the redirection, interactive content placed by a content selection service may be associated with a universal resource locator (URL) that corresponds to the network address to which the web browser is redirected.

### SUMMARY

One implementation is a method of using content selection universal resource locators (URLs). The method includes receiving, at one or more processors, a landing page URL of a third-party webpage to which a device is redirected when a piece of third-party content is selected at the device. The method also includes receiving, at one or more processors, a click-through URL to which the device reports when the piece of third-party content is selected at the device. The method further includes receiving a set of one or more URL parameters used to record data regarding the selection of the third-party content at the device. The method additionally includes generating a click-through URL template using the set of one or more URL parameters. The method also includes associating the click-through URL template with a node in a hierarchy representing an account of a provider of the third-party content. The method yet further includes using the click-through URL template to update a click-through URL associated with an item of third-party content of the provider.

Another implementation is a system for using content selection universal resource locators (URLs). The system includes one or more processors operable to receive a landing page URL of a third-party webpage to which a device is redirected when a piece of third-party content is selected at the device. The one or more processors are also operable to receive a click-through URL to which the device reports when the piece of third-party content is selected at the device. The one or more processors are further operable to receive a set of one or more URL parameters used to record data regarding the selection of the third-party content at the device. The one or more processors are additionally operable to generate a click-through URL template using the set of one or more URL parameters. The one or more processors are yet further operable to associate the click-through URL template with a node in a hierarchy representing an account of a provider of the third-party content. The one or more processors are additionally operable to use the click-through URL template to update a click-through URL associated with an item of third-party content of the provider.

A further implementation is a computer-readable storage medium having machine instructions stored therein that are executable by one or more processors to cause the one or more processors to perform operations. The operations include receiving a landing page URL of a third-party webpage to which a device is redirected when a piece of third-party content is selected at the device. The operations also include receiving a click-through URL to which the device reports when the piece of third-party content is selected at the device. The operations further include receiving a set of one or more URL parameters used to record data regarding the selection of the third-party content at the device. The operations also include generating a click-through URL template using the set of one or more URL parameters. The operations additionally include associating the click-through URL template with a node in a hierarchy representing an account of a provider of the third-party content. The operations yet further include using the click-through URL template to update a click-through URL associated with an item of third-party content of the provider.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in which third-party content is selected for presentation with first-party content;

FIG. 2 is an illustration of an electronic display showing a first-party webpage with embedded third-party content;

FIG. 3 is an illustration of one implementation of content selection URLs;

FIG. 4 is an illustration of one implementation of a hierarchy representing an account of a third-party content provider; and

FIG. 5 is a flow diagram of the steps taken in one implementation of a process for using URLs in a content selection service.

Like reference numbers and designations in the various drawings indicate like elements.

### DETAILED DESCRIPTION

According to various aspects of the present disclosure, one or more URLs may be associated with interactive content from a third-party content provider. As used herein, first-party content generally refers to the primary content requested by a user's device. For example, a first-party webpage may correspond to the website located at the URL entered by a user into his or her web browser. Also as used herein, third-party content generally refers to any content selected by a content selection service to be presented by the device in conjunction with first-party content. For example, a content selection service may select a third-party advertisement for presentation on a first-party webpage.

Certain third-party content may be interactive (e.g., the user of the receiving device may be able to interact with the content using an interface device) through the use of an associated URL. For example, the user may be able to click or otherwise select the third-party content using a mouse, other pointing device, touch screen display, or the like. In response, the user's device may be redirected to the URL associated with the interactive content. For example, clicking on a third-party advertisement may cause the user's browser to be redirected to the website of the advertiser.

Various types of content selection URLs may be associated with interactive third-party content. In some cases, the associated URL may simply be a landing page URL to which a web browser is redirected when the content is clicked at the device (e.g., a webpage of the third-party content provider). In further cases, the associated URL may be a click-through URL used for purposes of analyzing online traffic. For example, a web browser may first be redirected to a traffic analysis service located at the click-through URL and then redirected again by the analysis service to the landing page URL. In doing so, the traffic analysis service may record information regarding the user clicking or otherwise interacting with the third-party content.

Various URL parameters may be included in a content selection URL. In some implementations, a URL may include one or more parameters that affect how a landing page is presented. For example, a landing page URL may include the parameter “device_type=‘mobile’,” which identifies the client device as a mobile device. In response, the landing page may be optimized for presentation by a mobile device. In further implementations, a URL may include parameters that are used to analyze web traffic. For example, assume that an advertiser is running a Labor Day sale and that a given advertisement has a click-through URL that includes the parameter “campaign=‘Labor Day Sale’.” If the web browser is redirected to the corresponding traffic analysis service, the service may use this parameter to identify the click as attributable to the Labor Day sale advertising campaign.

In some implementations, a content selection service may crawl content selection URLs to evaluate the landing pages of third-party content for purposes of ensuring quality, compliance with a term of service, or the like. For example, the content selection service may simulate a user clicking on a third-party advertisement and analyze the webpage to which users are redirected. Based on this analysis, the content selection service may determine that the corresponding third-party content is not eligible for placement with first-party content by the selection service. For example, the content selection service may prevent the placement of third-party content that redirects users to a website that includes pornography, offensive content, does not match a stated topic of the third-party content (e.g., an advertisement for golf clubs links to a website selling insurance), etc.

In various cases, different URLs associated with different pieces of third-party content may lead a device to the same landing webpage. For example, multiple pieces of third-party content may have different click-through URLs that contain different traffic-related URL parameters but all redirect users to the same landing webpage. In further cases, a piece of third-party content may have an associated click-through URL via which a traffic analysis service controls the redirection to the landing page. In these and other cases, the content selection service may have to crawl each of these click-through URLs and redundantly analyze the same webpage any number of times.

According to various implementations, a content selection service may receive data from a third-party content provider that specifies a landing page URL, a click-through URL, and/or any URL parameters that the provider uses. Thus, the content selection service may be configured to identify which pieces of third-party content lead users to the same webpage. The content selection service may use this information to reduce the number of crawl operations that it performs. In one implementation, the content selection service may simply crawl one of the links to evaluate the content of the webpage. In another implementation, the content selection service may also crawl a random sampling of click-through URLs that all have the same specified landing page URL, to ensure that the provided information is accurate.

In some implementations, a landing page URL, click-through URL, and/or any URL parameters specified by a third-party content provider may be used by a content selection service to form URL templates. For example, assume that an advertiser uses the same traffic analysis service for all of its advertisements and that each advertisement uses the same base click-through URL (e.g., www.clickrecorder.test). In such a case, one click-through URL template may be based off of this URL. The template may also include any URL parameters used by the content provider (e.g., a customer ID parameter, a keyword parameter, etc.). This template may be used to create new advertisements with the content selection service and/or to update any existing click-through URLs used by the content provider. Similarly, a landing page URL template may include a base landing URL and may also have one or more URL parameters that affect the content of the landing page. Such a template may be used to create new advertisements or update advertisements, in various examples.

In one implementation, a URL template and/or a URL parameter may be associated with a node in a hierarchy that represents an account of a third-party content provider. For example, one possible hierarchy may be: account->campaign->content group (e.g., a grouping of one or more pieces of third-party content)->{third-party content, criteria}. A defined URL template and/or custom URL parameter may be propagated to any lower node, allowing a third-party content provider to quickly update the URLs associated with his or her content. For example, a third-party content provider may add a new URL parameter to a URL template at the campaign level and propagate the change to all third-party content in the campaign. In some cases, the content selection service may be configured to allow the content provider to select whether or not the propagation is applied to a particular node. For example, the content provider may propagate a new URL parameter to all URLs under a campaign, with the exception of a particular content group.

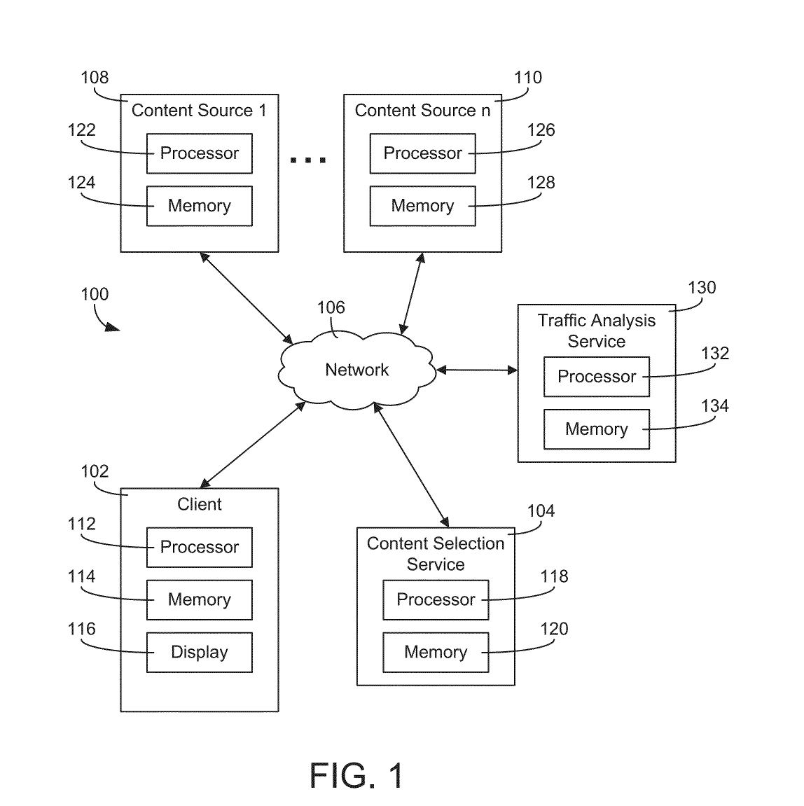

Referring to FIG. 1, a block diagram of a computer system 100 in accordance with a described implementation is shown. System 100 includes a client device 102 which communicates with other computing devices via a network 106. Client device 102 may execute a web browser or other application (e.g., a video game, a messenger program, a media player, a social networking application, etc.) to retrieve content from other devices over network 106. For example, client device 102 may communicate with any number of content sources 108, 110 (e.g., a first content source through nth content source). Content sources 108, 110 may provide webpage data and/or other content, such as images, video, and audio, to client device 102. Computer system 100 may also include a content selection service 104 configured to select third-party content to be provided to client device 102. For example, content source 108 may provide a first-party webpage to client device 102 that includes additional third-party content selected by content selection service 104. In one implementation, computer system 100 may include a traffic analysis service 130 which is notified when client device 102 is used to interact with third-party content selected by content selection service 104.

Network 106 may be any form of computer network that relays information between client device 102, content sources 108, 110, and content selection service 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client device 102 may communicate wirelessly (e.g., via WiFi, cellular, radio, etc.) with a transceiver that is hardwired (e.g., via a fiber optic cable, a CAT5 cable, etc.) to other computing devices in network 106.

Client device 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). In some implementations, the type of client device 102 may be categorized as being a mobile device, a desktop device (e.g., a device intended to remain stationary or configured to primarily access network 106 via a local area network), or another category of electronic devices (e.g., tablet devices may be a third category, etc.). Client device 102 is shown to include a processor 112 and a memory 114. Memory 114 may store machine instructions that, when executed by processor 112 cause processor 112 to perform one or more of the operations described herein. Processor 112 may include a microprocessor, ASIC. FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions.

Client device 102 may include one or more user interface devices. A user interface device may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interface devices may be internal to the housing of client device 102 (e.g., a built-in display, microphone, etc.) or external to the housing of client device 102 (e.g., a monitor connected to client device 102, a speaker connected to client device 102, etc.), according to various implementations. For example, client device 102 may include an electronic display 116, which displays webpages and other data received from content sources 108, 110 and/or content selection service 104. In various implementations, display 116 may be located inside or outside of the same housing as that of processor 112 and/or memory 114. For example, display 116 may be an external display, such as a computer monitor, television set, or any other stand-alone form of electronic display. In other examples, display 116 may be integrated into the housing of a laptop computer, mobile device, or other form of computing device having an integrated display.

Content sources 108, 110 may be one or more electronic devices connected to network 106 that provide content to devices connected to network 106. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, images, search results, other forms of electronic documents, and applications executable by client device 102. For example, content source 108 may be an online search engine that provides search result data to client device 102 in response to a search query. In another example, content source 110 may be a first-party web server that provides webpage data to client device 102 in response to a request for the webpage. Similar to client device 102, content sources 108, 110 may include processors 122, 126 and memories 124, 128, respectively, that store program instructions executable by processors 122, 126. For example, the memory 124 of content source 108 may include instructions such as web server software, FTP serving software, and other types of software that cause content source 108 to provide content via network 106.

According to various implementations, content sources 108, 110 may provide first-party webpage data to client device 102 that includes one or more content tags. In general, a content tag refers to any piece of webpage code associated with the action of including third-party content with a first-party webpage. For example, a content tag may define a slot on a webpage for third-party content, a slot for out of page third-party content (e.g., an interstitial slot), whether third-party content should be loaded asynchronously or synchronously, whether the loading of third-party content should be disabled on the webpage, whether third-party content that loaded unsuccessfully should be refreshed, the network location of a content source that provides the third-party content (e.g., content sources 108, 110, content selection service 104, etc.), a network location (e.g., a URL) associated with clicking on the third-party content, how the third-party content is to be rendered on a display, a command that causes client device 102 to set a browser cookie (e.g., via a pixel tag that sets a cookie via an image request), one or more keywords used to retrieve the third-party content, and other functions associated with providing third-party content with a first-party webpage. For example, content source 108 may serve first-party webpage data to client device 102 that causes client device 102 to retrieve third-party content from content selection service 104. In another implementation, content may be selected by content selection service 104 and provided by content source 108 as part of the first-party webpage data sent to client device 102. In a further example, content selection service 104 may cause client device 102 to retrieve third-party content from a specified location, such as memory 114 or content sources 108, 110.

Content selection service 104 and traffic analysis service 130 may each be one or more electronic devices connected to network 106. For example, services 104, 130 may be computer servers (e.g., FTP servers, file sharing servers, web servers, etc.) or a combination of servers (e.g., a data center, a cloud computing platform, etc.). Services 104, 130 may also include processors 118, 132 and memories 120, 134, respectively. In cases in which services 104, 130 are combinations of computing devices, processors 118, 132 may represent the collective processors of the devices and memories 120, 134 may represent the collective memories of the devices. In further implementations, content selection service 104 and traffic analysis service 130 may be combined to perform both content selection and traffic analysis.

Content selection service 104 may be configured to select third-party content for client device 102 (i.e., content selection service 104 may provide a third-party content selection service). In one implementation, the selected third-party content may be provided by content selection service 104 to client device 102 via network 106. For example, content source 110 may upload the third-party content to content selection service 104. Content selection service 104 may then provide the third-party content to client device 102 to be presented in conjunction with first-party content provided by any of content sources 108, 110. In other implementations, content selection service 104 may provide an instruction to client device 102 that causes client device 102 to retrieve the selected third-party content (e.g., from memory 114 of client device 102, from content source 110, etc.). For example, content selection service 104 may select third-party content to be provided as part of a first-party webpage being visited by client device 102 or within a first-party application being executed by client device 102 (e.g., within a game, messenger application, etc.).

According to various implementations, third-party content selected by content selection service 104 may be associated with one or more URLs. Such URLs may be specified to content selection service 104 by the provider of the third-party content and stored in memory 120 for future retrieval. For example, a particular piece of third-party content may be associated with a URL for content source 108 (e.g., a landing page URL) or a URL for traffic analysis service 130 (e.g., a click-through URL). A URL associated with third-party content may be provided with the third-party content to client device 102 by content selection service 104. For example, an advertisement selected by the service may be sent with a URL to which client device 102 is redirected if the advertisement is clicked. In various implementations, content selection service 104 may send a click-through URL, a landing page URL, or both to client device 102 in conjunction with third-party content. In some cases, content selection service 104 may send a click-through URL to client device 102 (e.g., a URL to traffic analysis service 130) and also store the landing page URL to which client device 102 will eventually be redirected if the third-party content is clicked. In a further implementation, content selection service 104 may send a landing page URL and one or more click-through URLs in conjunction with a piece of third-party content. For example, client device 102 may send requests to both the landing page URL and the one or more click-through URLs simultaneously (e.g., using HTML5 or a similar language that supports simultaneous requests).

In some implementations, content selection service 104 may store and retrieve URL parameters specified by a third-party content provider. In general, URL parameters may be classified as either pertaining to the recordation of an interaction with the third-party content (e.g., a traffic-related parameter) or used to affect how the landing webpage is presented (e.g., a landing page parameter). A URL parameter used by content selection service 104 may correspond to any portion of a URL, such as a domain name (e.g., http://{MYDOMAIN}/page? . . . ), a partial portion of a parameter used by the web server (e.g., http://example.test/?parameters={TEST}prefix, where TEST is a partial part of parameters={TEST}prefix), or may include the entirety of a parameter or set of parameters used by the web server. In one implementation, a URL parameter may be used by content selection service 104 as a delimiter within a URL to indicate extraneous parameters in the URL that do not affect the content of the landing page. In some cases, a URL parameter may identify an account number, a campaign identifier, a keyword, the a device type, a color, a font, the third-party content itself, or any other information that may be used to analyze interactions with the provider's content. For example, a click-through URL sent to traffic analysis service 130 when the third-party content is clicked may include information that may be used to break down aggregate traffic information (e.g., how many clicks resulted from a particular advertising campaign, how many clicks resulted from a particular device type, etc.). A click-through URL may even include a landing page URL. For example, a click-through URL used by traffic analysis service 130 may include a URL used by content source 110 that is used to redirect client device 102 to content source 110 after the click was recorded. A URL parameter may also include information that controls how a landing page is presented, such as a device type (e.g., to present a mobile or desktop optimized webpage), a language, a location, or any other such information. For example, a landing page URL for content source 110 may include a URL parameter that affects the content of the webpage sent to client device 102.

Content selection service 104 may be configured to allow one or more URL templates to be created for a third-party content provider. In one implementation, a base landing page URL may be specified by a third-party content provider, as well as any content-affecting URL parameters to be included in the URL. For example, one possible landing page URL template may be:

www.example.test/buy/?{_device}%kid={_criteria}, where {_device} and {_criteria} are example URL parameters that affect the content of the returned webpage, and www.example.test/buy/ is the base URL. In another example, a landing page URL template may be:
{ifmobile:www.example.mobi}{ifnotmobile:www.example.test}/buy/?{device}%kid={_criteria}. In this case, a client device may be directed to either a desktop or mobile website, depending on its device type. In other words, {device} may function as a placeholder that gets instantiated when the third-party content is selected. Other example placeholders may operate to determine values at the time of content selection regarding the network, geographic location, or any other characteristic of the client device, third-party content, or first-party content. In a further implementation, a click-through URL template may include the base click-through URL and any URL parameters that are used for purposes of analyzing traffic. For example, one click-through URL template may be:
www.clickrecording.test/{_account}/?campaign={_campaign}&randomStuff%/kw={_keyword} where www.clickrecording.test is the base click-through URL and {_account}, {_campaign}, and {_keyword} are URL parameters. In a further implementation, content selection service 104 may utilize a parameter associated with a URL that designates whether the URL is specific to a particular device type (e.g., mobile devices, desktop devices, etc.), in addition to, or in lieu of, a URL parameter that designates the device type.

In one implementation, content selection service 104 may utilize a data structure that represents the hierarchy of an account of a third-party content provider. The hierarchy may be structured in any way that subdivides the account of the third-party content provider. For example, one possible hierarchy may be: account->campaign->content group (e.g., a grouping of one or more pieces of third-party content that may be assigned to a campaign)->{piece of third-party content, criteria}.

In various implementations, URL parameters, landing page URLs, and/or click-through URLs specified by a third-party content provider may be used by content selection service 104 to create URL templates. For example, assume that a third-party advertiser always uses a particular URL parameter and particular landing page URL for each of his or her advertisements. In such a case, the provider may create a landing page URL template via content selection service 104 that may be used to associate a landing page with a new advertisement. In some implementations, URL parameters and/or a URL template may be associated with a node of a hierarchy representing the account of a third-party content provider. The contents of the URL template or URL parameters may also be propagated to any lower node in the hierarchy. For example, assume that a third-party advertiser is running two different campaigns: a first campaign promoting a sale on patio furniture and a second campaign promoting a sale on shoes. Also assume that advertisements under each campaign are to be associated with different landing pages of the advertiser's website. In such a case, a landing page URL template may be associated with each node at the campaign level to propagate the different landing page URLs to the advertisements under each campaign. In some implementations, content selection service 104 may utilize one or more parameters that control whether or not a lower node in the hierarchy inherits the URL template or URL parameters of a higher node. For example, a third-party content provider may turn off the inheritance for a particular content group under a campaign having an associated URL parameter.

According to various implementations, content selection service 104 may insert a value of a URL parameter into a URL template to generate a click-through or landing page URL. For example, assume that a click-through URL template includes the URL parameter {_account}. During generation of a click-through URL using the template, content selection service 104 may insert_account=“cid=89056” into the generated URL.

Content selection service 104 may crawl the URLs associated with third-party content. For example, content selection service 104 may simulate a user clicking on a piece of third-party content to analyze the landing page to which the user would be redirected. In some cases, the landing page URL may be hotlinked directly to the content (e.g., clicking on an advertisement redirects the browser directly to the advertiser's website). In other cases, a click-through URL may be hotlinked directly to the content (e.g., the browser may be redirected first to a traffic analysis service and then redirected one or more times before arriving at the landing page). Content selection service 104 may analyze the content of the landing page to ensure that the landing page conforms to the terms of service of content selection service 104. Content selection service 104 may also analyze the content of the landing page for purposes of ensuring quality. For example, content selection service 104 may determine whether the content of the landing page matches the content of an advertisement (e.g., to ensure that the subject of the advertisement coincides with that of the landing page). In some implementations, a URL parameter may act as a delimiter within a URL to indicate extraneous parameters of the URL that do not affect the content of the landing page. In such cases, content selection service 104 may use this information to reduce the number of URLs that are crawled.

In cases in which content selection service 104 receives landing page URL, click-through URL, and/or URL parameter information from a third-party content provider, content selection service may crawl a sampling of third-party content that have the same landing page URL. In one implementation, the crawled URLs may be click-through URLs and content selection service 104 may determine whether the corresponding landing page URL specified by the provider matches the crawled landing page. Thus, content selection service 104 may analyze the content of a landing page once or only a limited number of times, in some implementations.

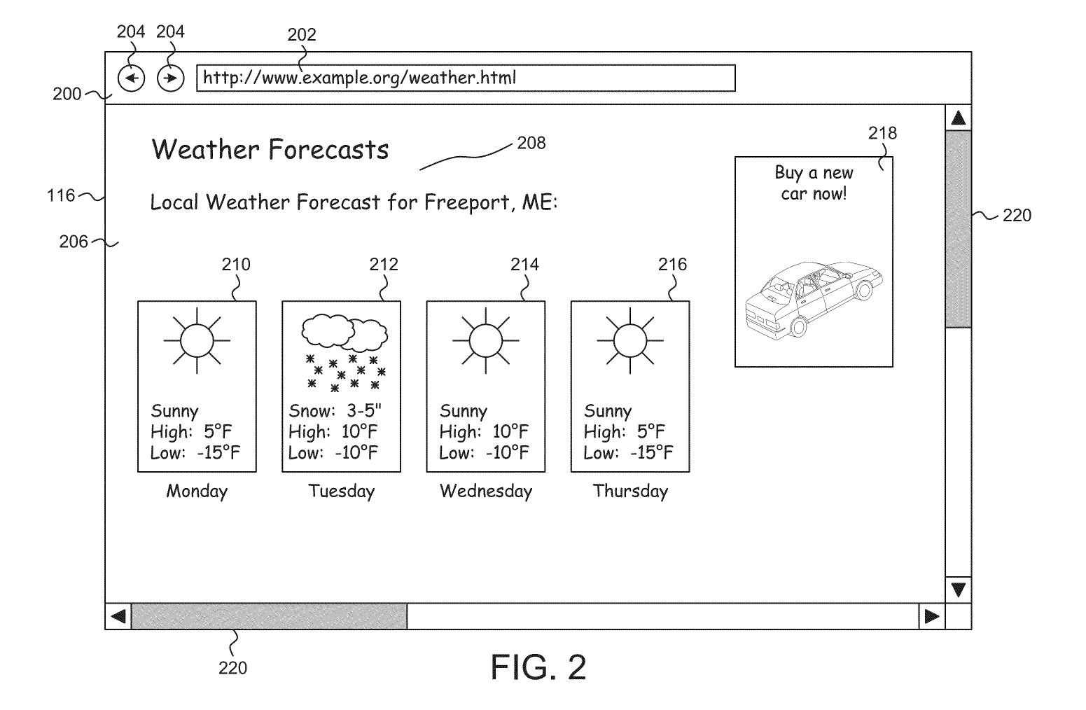

Referring now to FIG. 2, an illustration is shown of electronic display 116 displaying an example first-party webpage 206. Electronic display 116 is in electronic communication with processor 112 which causes visual indicia to be displayed on electronic display 116. As shown, processor 112 may execute a web browser 200 stored in memory 114 of client device 102, to display indicia of content received by client device 102 via network 106. In other implementations, another application executed by client device 102 may incorporate some or all of the functionality described with regard to web browser 200 (e.g., a video game, a chat application, etc.).

Web browser 200 may operate by receiving input of a uniform resource locator (URL) via a field 202 from an input device (e.g., a pointing device, a keyboard, a touch screen, etc.). For example, the URL, http://www.example.org/weather.html, may be entered into field 202. Processor 112 may use the inputted URL to request data from a content source having a network address that corresponds to the entered URL. In other words, client device 102 may request first-party content accessible at the inputted URL. In response to the request, the content source may return webpage data and/or other data to client device 102. Web browser 200 may analyze the returned data and cause visual indicia to be displayed by electronic display 116 based on the data.

In general, webpage data may include text, hyperlinks, layout information, and other data that may be used to provide the framework for the visual layout of first-party webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “weather.html” provided by the website, “www.example.org.” The webpage data may include data that specifies where indicia appear on first-party webpage 206, such as text 208. In some implementations, the webpage data may also include additional URL information used by web browser 200 to retrieve additional indicia displayed on first-party webpage 206. For example, the file, “weather.html,” may also include one or more instructions used by processor 112 to retrieve images 210-216 from their respective content sources.

Web browser 200 may include a number of navigational controls associated with first-party webpage 206. For example, web browser 200 may be configured to navigate forward and backwards between webpages in response to receiving commands via inputs 204 (e.g., a back button, a forward button, etc.). Web browser 200 may also include one or more scroll bars 220, which can be used to display parts of first-party webpage 206 that are currently off-screen. For example, first-party webpage 206 may be formatted to be larger than the screen of electronic display 116. In such a case, the one or more scroll bars 220 may be used to change the vertical and/or horizontal position of first-party webpage 206 on electronic display 116.

First-party webpage 206 may be devoted to one or more topics. For example, first-party webpage 206 may be devoted to the local weather forecast for Freeport, Me. In some implementations, a content selection server, such as content selection service 104, may analyze the contents of first-party webpage 206 to identify one or more topics. For example, content selection service 104 may analyze text 208 and/or images 210-216 to identify first-party webpage 206 as being devoted to weather forecasts. In some implementations, webpage data for first-party webpage 206 may include metadata that identifies a topic.

In various implementations, content selection service 104 may select some of the content presented on first-party webpage 206 (e.g., an embedded image or video, etc.) or in conjunction with first-party webpage 206 (e.g., in a pop-up window or tab, etc.). For example, content selection service 104 may select third-party content 218 to be included on webpage 206. In some implementations, one or more content tags may be embedded into the code of webpage 206 that defines a content field located at the position of third-party content 218. Another content tag may cause web browser 200 to request additional content from content selection service 104, when first-party webpage 206 is loaded. Such a request may include one or more keywords, a device identifier for client device 102, or other data used by content selection service 104 to select content to be provided to client device 102. In response, content selection service 104 may select third-party content 218 for presentation on first-party webpage 206.

Content selection service 104 may select third-party content 218 (e.g., an advertisement) by conducting a content auction, in some implementations. Content selection service 104 may also determine which third-party content providers compete in the auction based in part on campaign parameters set by the providers. For example, only content providers that specified a topic that matches that of webpage 206, an interest category of a device identifier accessing webpage 206, or webpage 206 specifically may compete in the content auction. Based on bidding parameters for these third-party content providers, content selection service 104 may compare their bid amounts, quality scores, and/or other values to determine the winner of the auction and select third-party content 218 for presentation with webpage 206.

In some implementations, content selection service 104 may provide third-party content 218 directly to client device 102. In other implementations, content selection service 104 may send a command to client device 102 that causes client device 102 to retrieve third-party content 218. For example, the command may cause client device 102 to retrieve third-party content 218 from a local memory, if third-party content 218 is already stored in memory 114, or from a networked content source. In this way, any number of different pieces of content may be placed in the location of third-party content 218 on first-party webpage 206. In other words, one user that visits first-party webpage 206 may be presented with third-party content 218 and a second user that visits first-party webpage 206 may be presented with different content. Other forms of content (e.g., an image, text, an audio file, a video file, etc.) may be selected by content selection service 104 for display with first-party webpage 206 in a manner similar to that of third-party content 218. In further implementations, content selected by content selection service 104 may be displayed outside of first-party webpage 206. For example, content selected by content selection service 104 may be displayed in a separate window or tab of web browser 200, may be presented via another software application (e.g., a text editor, a media player, etc.), or may be downloaded to client device 102 for later use.

Third-party content 218 may be interactive content and may be hotlinked to one or more URLs. For example, clicking on third-party content 218 may cause web browser 200 to navigate to a hotlinked click-through URL or landing-page URL. In one implementation, web browser 200 may navigate to both types of URLs at the same time, such as via the ping function in HTML 5. If the hotlinked URL for third-party content 218 is a click-through URL, it may redirect web browser 200 to a traffic analysis service, such as traffic analysis service 130. In turn, the traffic analysis service may send a redirection command to web browser 200 that causes web browser 200 to navigate to another traffic analysis service or to the landing page for third-party content 218.

A hotlinked URL associated with third-party content 218 may include any number of different URL parameters. For example, a click-through URL associated with third-party content 218 may include URL parameters that provide context surrounding the click to a traffic analysis service. These parameters may be used by the traffic analysis service for purposes of aggregating information about the clicks, such as reporting on webpage 206, one or more keywords associated with third-party content 218, information regarding third-party content 218 (e.g., the campaign, content group, etc. of the third-party content provider), or the like. In another example, a landing page URL associated with third-party content 218 may include URL parameters that affect the content of the landing page and/or how the landing page is presented.

In some cases, the landing page of the third-party content provider may not be the final webpage arrived at by web browser 200 in response to an interaction with third-party content 218 (e.g., the content is clicked or otherwise selected by an interface device). For example, a landing page URL may include a URL parameter that identifies the type of device (e.g., mobile vs. desktop) that controls whether the device is redirected to a mobile or desktop optimized website. In such a case, a content selection service may analyze the final webpage in addition to, or in lieu of, the landing page via link crawling.

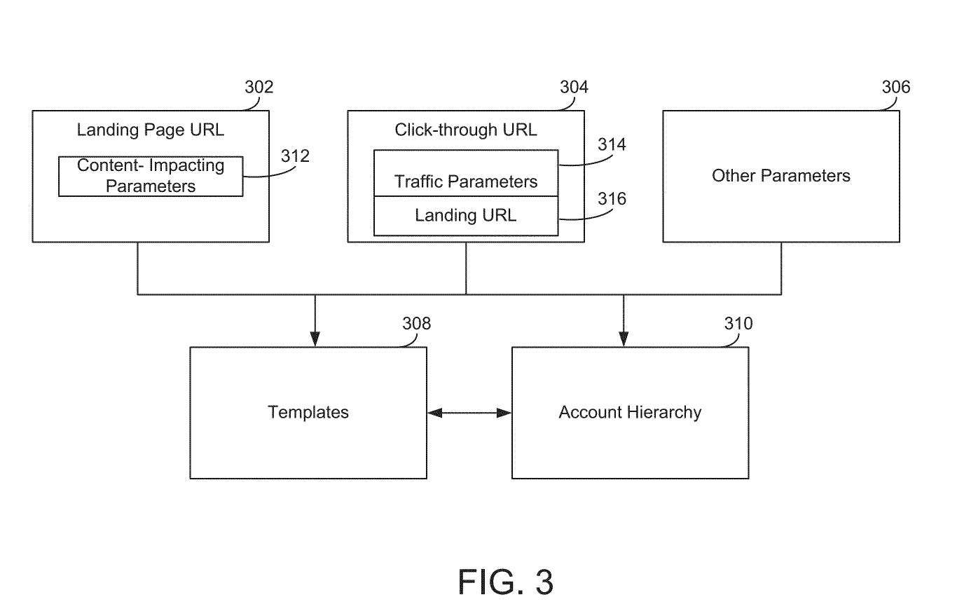

Referring now to FIG. 3, an illustration is shown of one implementation of content selection URLs. As shown, various data may be stored and retrieved by a content selection service regarding the URLs associated with third-party content available for selection by the service. The data may be supplied, for example, by a third-party content provider as part of the management of his or her account with the content selection service. For example, an advertiser may be prompted to supply certain URL information when creating a new advertisement.

The content selection service may store and retrieve a landing page URL 302 specified by a third-party content provider. In general, a landing page may be any webpage of a third-party content provider to which a web browser is redirected when third-party content is selected at a client device (e.g., when a user clicks on a third-party advertisement). In some cases, the content selection service may require all third-party content providers to specify a landing page URL for clickable content. For example, an online retailer may specify the URL of its online store as the landing page for its advertisements. One or more content-impacting parameters 312 may also be stored and retrieved with landing page URL 302. Content-impacting parameters 312 may include any parameters that may be used by a third-party content provider to tailor the returned webpage to a particular client device.

In some implementations, the content selection service may store and retrieve a click-through URL specified by a third-party content provider. In contrast to a landing page URL, a click-through URL generally refers to a URL provided by another entity than that of the third-party content provider, such as a traffic analysis service. By sending a request to such a service at the URL, the service is able to identify that the third-party content was clicked at a client device and may store such information for purposes of reporting. A click-through URL may also cause a client device to be redirected to another click-through URL or to a landing-page URL of the third-party content provider. For example, clicking on an advertisement may cause a web browser to navigate to a click-through URL of a traffic analysis service which records the click and redirects the browser to the advertiser's website.

In some implementations, one or more traffic-related URL parameters 314 may be stored and retrieved in conjunction with click-through URL 304. In general, traffic-related parameters 314 may be any URL parameters used with click-through URL 304 that provide context to a recorded click for purposes of traffic analysis. For example, traffic-related parameters 314 may include parameters that identify a keyword associated with the selected third-party content, the third-party content provider, a campaign, the clicked piece of third-party content, a device type, the first-party webpage, a geographic location, combinations thereof, or the like. When received by a traffic analysis service, such parameters may be used by the service to generate various reports for the third-party content provider. For example, the traffic analysis service may generate a report that allows the third-party content provider to assess how well the different pieces of third-party content used by the content provider performed in a particular advertising campaign.

A click-through URL may be translated into a landing page URL by a traffic analysis service in various ways. In some cases, traffic-related parameters 314 of click-through URL 304 may include a landing page URL 316 as a URL parameter. In response to receiving a request at click-through URL 304, the traffic analysis service may parse the URL parameter containing landing page URL 316 and return landing page URL 316 to the web browser as part of a redirection instruction. In another case, landing page URL 316 may be replaced in a URL parameter by an identifier used internally by the traffic analysis service. For example, a traffic-related parameter for click-through URL 304 may be “&lp=54321” where 54321 represents the landing page URL within the traffic analysis service. In turn, the traffic analysis service may return the corresponding landing page URL to the web browser as part of a redirection instruction.

The content selection service may require landing page URL 302 to be specified with click-through URL 304, regardless of how the traffic analysis service performs the redirection to the landing page. For example, landing page URL 302 may be required, even if the traffic analysis service uses its own internal identifiers as URL parameters to perform the redirection. In one implementation, the content selection service may aggregate specified landing page URLs to crawl the third-party content (e.g., to ensure the landing page or final page conforms to the terms of service, for purposes of quality assurance, etc.). For example, assume that landing page URL 302 is associated with ten different advertisements from the same advertiser. In such a case, the content selection service may crawl only one or a reduced number of the advertisements, since the landing page is the same. In a further case, the content selection service may navigate directly to landing page URL 302 to analyze the content of the corresponding webpage. In one implementation, the content selection service may crawl a sampling of the click-through URLs for third-party content having the same specified landing page URLs, to ensure the accuracy of the landing page URLs. In other words, the content selection service may verify that a landing page URL specified by the third-party content provider is actually the URL to which users are redirected.

Other parameters 306 may also be stored and retrieved by the content selection service. In general, other parameters 306 may include any individual URL parameters specified by a third-party content provider that are not specified by the provider as part of a specific URL. Other parameters 306 may be traffic-related URL parameters and/or content-impacting URL parameters, in various implementations. Other parameters 306 may include standardized URL parameters used by the content selection service and/or any custom URL parameters used internally by a traffic analysis service or third-party content provider.

According to various implementations, one or more URL templates 308 may be generated using landing page URL 302, click-through URL 304, and/or other URL parameters 306. In one implementation, URL templates 308 may include a landing page URL template that templatizes the content-impacting parameters used in the provider's landing page URLs. For example, a landing page URL may be:

www.example.test/?param1={param1} where {param1} represents a templatized URL parameter and www.example.test is the base URL for the landing page. In another implementation, URL templates 308 may include a click-through URL template. The click-through URL template may include a base click-through URL for the traffic analysis service and one or more templatized URL parameters used for purposes of traffic analysis. For example, a click-through URL template may be
www.trafficanalysis.test/{_account}/?campaign={_campaign}&randomStuff%kw={key word} where {_account}, {_campaign}, and {keyword} are templatized URL parameters.

Landing page URL 302, click-through URL 304, other parameters 306, and/or URL templates 308 may be associated with nodes of an account hierarchy 310. In general, account hierarchy 310 may be any hierarchical representation of an account for a third-party content provider. For example, a third-party content provider may associate a landing page URL template from templates 308 with an account-level node of account hierarchy 310. Such a template may be used to associate a landing page with all third-party content under the account. In another example, a URL parameter in other parameters 306 may be associated with a specific piece of third-party content represented by a node in account hierarchy 310.

In some implementations, lower nodes in account hierarchy 310 may inherit the properties of any URLs, URL templates, and/or URL parameters associated with a higher node in account hierarchy 310. For example, a URL parameter that includes an identifier used to identify the third-party content provider may be associated with the topmost node in account hierarchy 310 and propagated to each click-through URL in account hierarchy 310. In one implementation, the propagation of a URL, URL template, and/or URL parameters within account hierarchy 310. For example, a campaign-level URL template may be selectively applied to each content group under the campaign (e.g., the third-party content provider may elect not to use the URL template in a particular content group under the campaign.

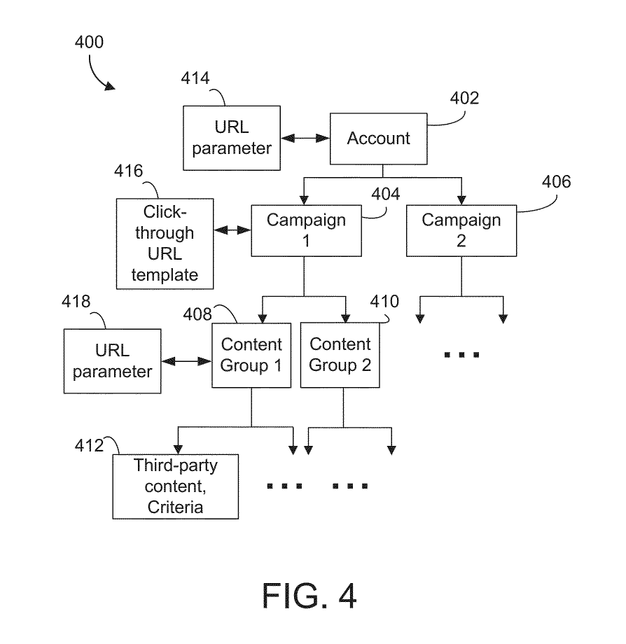

Referring now to FIG. 4, an illustration is shown of one implementation of a hierarchy representing an account of a third-party content provider. As shown, account hierarchy 400 may include any number of nodes that represent different levels of the third-party content provider's account with a content selection service. In various implementations, other hierarchical arrangements may also be used to group and classify third-party content used as part of the account of the provider than those depicted in account hierarchy 400.

In one implementation, account hierarchy 400 may include up to four levels of organization for an account of a third-party content provider and represent each level as a node in the hierarchy. At the topmost node of the hierarchy may be an account-level node 402 that represents the entirety of the provider's account with the content selection service. Under account-level node 402 may be any number of campaign-level nodes, such as a first campaign-level node 404 and a second campaign-level node 406. Each of nodes 404, 406 may represent, for example, different advertising campaigns used by the third-party content provider (e.g., different promotions, different sales, different advertising themes, etc.).

In some cases, a campaign may include one or more content groups. For example, content group-level nodes 408, 410 may be located under campaign-level node 404 in account hierarchy 400. In general, a content group refers to a grouping of one or more pieces of third-party content that have at least one common attribute. A content group may be a group of advertisements that use the same auction parameters (e.g., keywords or other parameters used to control where the third-party content is placed), specific placement parameters (e.g., to place the content with a specific website or other piece of first-party content), a common theme, or the like. For example, assume that campaign-level node 404 represents a Labor Day sales campaign of an advertiser and that the advertiser is holding closeout sales on both patio furniture and on swimwear. In such a case, the advertiser may create a first content group for advertisements promoting the Labor Day sale on patio furniture and a second content group for advertisements promoting the Labor Day sale on swimwear.

Under a content group node in account hierarchy 400 may be any number of nodes that represent individual pieces of third-party content. For example, third-party content node 412 may be grouped under content group-level node 408. Associated with each piece of third-party content may be selection criteria specified by the third-party content provider and used by the content selection service to place the content with first-party content. Selection criteria may be auction parameters, specific placement parameters, or any other parameter used by the selection service to control when and how the piece of third-party content is presented at a client device. For example, the third-party content represented by node 412 may have one or more keywords specified by the third-party content provider that are used by the selection service to determine where the content is placed (e.g., on a webpage that uses the same or similar keywords).

According to various implementations, a click-through URL, a landing page URL, a click-through URL template, a landing page URL template, and/or a URL parameter may be associated with any of the nodes in account hierarchy 400. In one implementation, the content selection service may impose a rule that, at minimum, a landing page URL or URL template is to be associated with each node in account hierarchy 400. In such a case, the resulting landing page URL may be included with the third-party content when presented at a client device (e.g., the device will be redirected to the landing page if the user of the device clicks or otherwise selects the third-party content using an interface device). In some implementations, a click-through URL or URL template may be defined for one or more nodes in account hierarchy 400. In various implementations, the third-party content may be hotlinked to the click-through URL in lieu of the landing page URL (e.g., if the click-through URL will eventually cause the client device to be redirected to the landing page) or in addition thereto (e.g., if the third-party content is configured to navigate to both URLs at the same time, when the third-party content is clicked).

In some implementations, a lower node in account hierarchy 400 may inherit any specified URLs, URL templates, or URL parameters associated with a higher level node. As shown, assume that a click-through URL template 416 is associated with campaign-level node 404. In such a case, each piece of third-party content under the corresponding campaign may utilize the same format in their respective click-through URLs. For example, assume that click-through URL template 416 has the following: www.trafficanalysis.test/{_account}/?campaign={_campaign}&randomStuff%kw={key word}. In one implementation, the URL parameters {_account}, {_campaign}, and {keyword} may be replaced with the appropriate information from account hierarchy 400. For example, click-through URL template 416 may cause the click-through URL associated with the third-party content at node 412 to be the following:

www.trafficanalysis.test/89056/?campaign=Labor+Day/&randomStuff&kw=patio+furniture, where 89056 is an account identifier for the third-party content provider, “Labor+Day” is a campaign identifier, and “patio+furniture” represents a set of keywords associated with the advertisement that are used by the content selection service to determine when to place the advertisement (e.g., if the content of the webpage matches the keywords associated with the advertisement). In one implementation, the ordering of URL parameters in a URL template may be maintained by the content selection service when generating the finalized URL.

In some implementations, a URL parameter may be associated with a node of account hierarchy 400. As shown, for example, a URL parameter 414 may be associated with account-level node 402. For example, URL parameter 414 may be a URL parameter that the third-party content provider wishes to use in all or most of the landing-page URLs of the third-party content provider. Also as shown, another URL parameter 418 may be associated with content group-level node 408, thereby including the URL parameter in any click-through URL for content in the content group. URL parameters 414, 418 may also include URL parameter values that may be inherited at any lower node or overwritten explicitly at a lower node.

In one implementation, a defined URL parameter anywhere in account hierarchy 400 may be used to generate a URL template at any level in account hierarchy 400. For example, assume that URL parameter 418 already exists. In such a case, the third-party content provider may select URL parameter 418 for inclusion with click-through URL template 416. During generation of a URL using the template, the value of a defined URL parameter associated with hierarchy 400 may be included in the template. In one implementation, URL parameters 414, 418 may be custom parameters defined by the third-party content provider or part of a set of URL parameters predefined by the content selection service (e.g., the content selection service may maintain a set of commonly used URL parameters). In some cases, a custom URL parameters may include a special character string to prevent overlap between custom URL parameters and predefined URL parameters. For example, a custom URL parameter may be required to begin with an underscore or other character. In one implementation, a URL parameter, URL template, or URL associated with a higher node in account hierarchy 400 may be inherited by any lower node. In another implementation, the inheritance of a URL parameter, URL template, or URL from a higher node in account hierarchy 400 may be overridden with another value at a lower node. In yet a further implementation, a URL parameter may have different values at different nodes in hierarchy 400. In such a case, the value of the URL parameter at a lower node may override that of the value of the URL parameter at the higher node. For example, if URL parameters 414, 418 include different values for the same parameter, the value of URL parameter 418 may override the value of URL parameter 414 at node 408 and/or any nodes below node 408 (e.g., node 412, etc.).

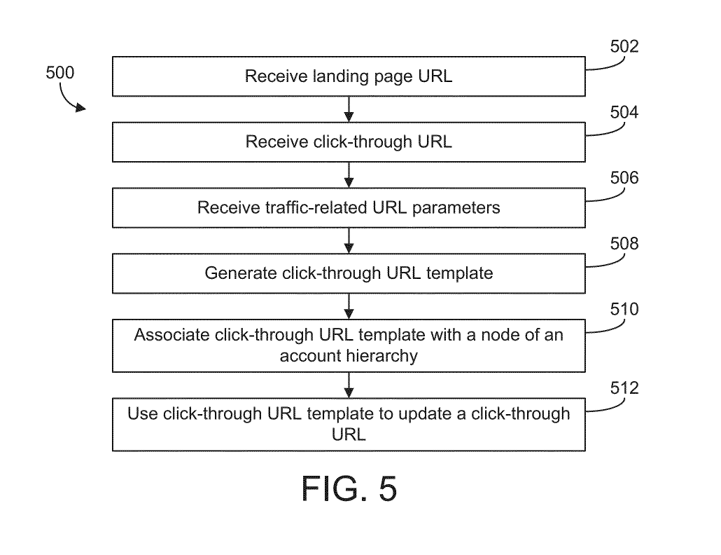

Referring now to FIG. 5, a flow diagram is shown depicting the steps taken in one implementation of a process 500 for using URLs in a content selection service. Process 500 includes receiving a landing page URL (step 502), receiving a click-through URL (step 504), receiving traffic-related URL parameters (step 506), generating a click-through URL template (step 508), associating the click-through URL template with a node of an account hierarchy (step 510), and using the click-through URL template to update a click-through URL (step 512). Process 500 may be implemented by any computing device or set of computing devices, such as by content selection service 104 shown in FIG. 1. In general, process 500 allows both a landing page URL and a click-through URL to be associated with one or more pieces of third-party content. In addition, process 500 allows a click-through URL template to be used to update the click-through URLs associated with one or more pieces of third-party content.

Still referring to FIG. 5, process 500 includes receiving a landing page URL (step 502). In general, a landing page URL refers to a network address of any webpage of a third-party content provider to which a device is redirected when third-party content from the provider is clicked or otherwise selected via a user interface device. The landing page URL may be associated with one or more pieces of third-party content. For example, clicking on a third-party advertisement may cause a web browser to be redirected to the website of the advertiser (e.g., the advertisement is hyperlinked to the landing page URL). In some cases, indirect navigation may occur to the landing page URL, such as when the web browser is first redirected to a traffic analysis service and then redirected to the landing page.

Yet still referring to FIG. 5, process 500 includes receiving a click-through URL (step 504). In general, a click-through URL refers to a network address of a traffic analysis service that records information regarding an interaction with third-party content, such as when the content is clicked. In various cases, the traffic analysis service may redirect a web browser to a landing page URL of the third-party content provider or to another traffic analysis service. For example, a piece of third-party content may be associated with a landing page URL of www.retailer.test and a click-through URL of www.trafficanalysis.test.

Still referring to FIG. 5, process 500 includes receiving one or more traffic-related URL parameters (step 506). In general, a traffic-related URL parameter refers to any parameter appearing as a portion of a click-through URL that is used for purposes of reporting that the third-party content was clicked or otherwise selected. For example, a traffic-related URL parameter may indicate the account, campaign, content group, selection criteria, etc. of a piece of third-party content. In another example, a traffic-related URL may indicate the type, location, etc. of the device that interacted with the third-party content. When the third-party content is clicked or otherwise selected at a client device, the client device navigates to the click-through URL, allowing a traffic analysis service to record the click. If additional traffic-related parameters are included in the click-through URL, the service may produce one or more reports that break down clicks on the third-party content. For example, the traffic analysis service may generate a report that breaks down clicks on the provider's content by campaign ID.

Yet still referring to FIG. 5, process 500 includes generating a click-through URL template (step 508). In various implementations, the click-through URLs used by a third-party content provider across different pieces of third-party content may be the same or may follow the same format. In various implementations, the generated click-through URL template may include any number of traffic-related URL parameters, such as those received in step 506. For example, assume that a third-party content provider wishes to produce traffic reports that break down clicks on the provider's content by device type based on a URL parameter of {device}. In such a case, a URL template of www.trafficanalysis.test/ . . . /{device} may be generated.

Still referring to FIG. 5, process 500 includes associating the click-through URL template with a node of an account hierarchy (step 510). The account hierarchy may represent any logical ordering for the account of the third-party content provider with a content selection service. For example, one possible hierarchy for an account may be account->campaign->content group->{content, selection criteria}. In some implementations, the click-through URL template may be inherited by any or all nodes lower in the hierarchy. For example, a click-through URL template associated with a campaign-level node may be inherited by any content group-level or content-level nodes under the campaign. In one implementation, inheritance of the click-through URL template may be controlled by one or more parameters of the content selection service, allowing the third-party content provider to control which nodes inherit the URL template.

Still referring to FIG. 5, process 500 includes using the click-through URL template to update a click-through URL (step 512). In one implementation, a click-through URL associated with a piece of third-party content may be updated using a URL template associated at a higher node than it in the account hierarchy (e.g., at the account, campaign, or content group level). In another implementation, an undefined click-through URL may be updated using the URL template (e.g., to associate a new click-through URL with a piece of third-party content). In one example, assume that a particular advertisement is associated with the click through URL:

www.trafficanalysis.test/12345/?campaign=Labor+Day&keyword=Patio+Set. Also, assume that the third-party content provider wishes to add another URL parameter that identifies the type of client device that clicked on the third-party content. In such a case, a URL template of
www.trafficanalysis.test/{_account}/?{_campaign}&{keyword}&{device} may be used to update the click-through URL, thereby adding an extra URL parameter to the URL that identifies the device type (e.g., {device}).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube). LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

1. A method for templatizing content selection universal resource locators comprising:
receiving, at one or more processors, a URL template defined by a content provider, the URL template specifying a portion of a webpage URL to which a device is redirected responsive to selection of a piece of content and one or more parameter placeholders;
associating, using one or more processors, the URL template with a first node of a hierarchy of an account of the content provider, the first node associated with a first piece of content and a second piece of content;
receiving, at one or more processors, a first parameter value associated with the first node, a second parameter value associated with a second node, and a third parameter value associated with a third node, wherein the first node, second node, and third node are separate nodes of the hierarchy, wherein the second node is associated with the first piece of content and the third node is associated with the second piece of content;
generating, using one or more processors, a first click-through URL for the first piece of content based on the URL template, the first parameter value, and the second parameter value;
generating, using one or more processors, a second click-through URL for the second piece of content based on the URL template, the first parameter value, and the third parameter value;
receiving, at one or more processors, a modification from the content provider to the URL template; and
updating, using one or more processors, the first click-through URL and the second click-through URL based on the received modification to the URL template.

2. (canceled)

3. The method of claim 1, wherein the URL template comprises a landing page template and the first parameter value is a landing page parameter value, wherein the first click-through URL includes a landing page URL based on the landing page template and the first parameter value, the method further comprising:
associating, using one or more processors, the landing page URL with the node of the hierarchy.

4. The method of claim 3 further comprising:
crawling a landing page of the first click-through URL to determine whether the landing page of the first click-through URL matches a landing page of the landing page URL associated with the node.

5. The method of claim 4 further comprising:
analyzing, using one or more processors, one of the landing page of the first click-through URL or the landing page of the landing page URL associated with the node to determine whether the landing page conforms to a term of service.

6. The method of claim 1, wherein the first parameter value includes a landing page URL.

7. (canceled)

8. The method of claim 1, wherein the node comprises one of: an account level node, a campaign level node, or a content group level node.

9. A system for templatizing content selection universal resource locators comprising:
one or more processors; and one or more storage devices storing instructions that, when executed by the one or more processors, cause the one or more processors to perform operations comprising:
receiving a URL template defined by a content provider, the URL template specifying a portion of a webpage URL to which a device is redirected responsive to selection of a piece of content and one or more parameter placeholders;
associating the URL template with a node defined by the content provider of a hierarchy of an account of the content provider, the node associated with a first piece of content and a second piece of content;
receiving a first parameter value associated with the node;
generating a first click-through URL for the first piece of content based on the URL template and the first parameter value;
generating a second click-through URL for the second piece of content based on the URL template and the first parameter value;
receiving a modification to the URL template from the content provider; and
updating the first click-through URL and the second click-through URL based on the received modification to the URL template.

10. (canceled)

11. The system of claim 9, wherein the URL template is a landing page template and the first parameter value is a landing page parameter value, the one or more storage devices storing instructions that cause the one or more processors to further perform operations comprising:
generating a landing page URL based on the URL template and the first parameter value; and
associating the landing page URL with the node of the hierarchy.

12. The system of claim 11, wherein the one or more storage devices store instructions that cause the one or more processors to further perform operations comprising:
crawling a landing page of the first click-through URL to determine whether the landing page of the first click-through URL matches a landing page of the landing page URL associated with the node.

13. The system of claim 12, wherein the one or more storage devices store instructions that cause the one or more processors to further perform operations comprising:
analyzing one of the landing page of the first click-through URL or the landing page of the landing page URL associated with the node to determine whether the landing page conforms to a term of service.

14. The system of claim 9, wherein the first parameter value includes a landing page URL.

15. (canceled)

16. The system of claim 9, wherein the node comprises one of: an account level node, a campaign level node, or a content group level node.

17. A non-transitory computer-readable storage medium having machine instructions stored therein that are executable by one or more processors to cause the one or more processors to perform operations comprising:
receiving a URL template defined by a content provider, the URL template specifying a portion of a webpage URL to which a device is redirected responsive to selection of a piece of content and one or more parameter placeholders;
associating the URL template with a node of a hierarchy of an account of the content provider, the node associated with a first piece of content and a second piece of content;
receiving a first parameter value associated with the node and associated with a parameter placeholder of the one or more parameter placeholders;
generating a first click-through URL for the first piece of content based on the URL template and the first parameter value by replacing the parameter placeholder of the one or more parameter placeholders of the URL template with the first parameter value;
generating a second click-through URL for the second piece of content based on the URL template and the first parameter value by replacing the parameter placeholder of the one or more parameter placeholders of the URL template with the first parameter value;
receiving a modification to the URL template from the content provider; and
updating the first click-through URL and the second click-through URL based on the received modification to the URL template.

18. (canceled)

19. The non-transitory computer-readable storage medium of claim 17, wherein the URL template is a landing page template and the first parameter value is a landing page parameter value, wherein the operations further comprise:
generating a landing page URL based on the URL template and the first parameter value; and
associating the landing page URL with the node of the hierarchy.

20. The non-transitory computer-readable storage medium of claim 19, wherein the operations further comprise:
crawling a landing page of the first click-through URL to determine whether the landing page of the first click-through URL matches a landing page of the landing page URL associated with the node.

21. (canceled)

22. The method of claim 6, wherein the URL template comprises a URL for a traffic analysis service, the method further comprising:
receiving, at one or more processors, a fourth parameter value associated with the second node of the hierarchy of the account of the content provider associated with the first piece of content, the fourth parameter value comprising a landing page parameter value;
receiving, at one or more processors, a fifth parameter value associated with the third node of the hierarchy of the account of the content provider associated with the second piece of content, the fifth parameter value comprising a landing page parameter value;
determining, using one or more processors, a first landing page URL for the first piece of content based on the landing page URL of the first parameter value and the fourth parameter value; and
determining, using one or more processors, a second landing page URL for the second piece of content based on the landing page URL of the first parameter value and the fifth parameter value.

23. The system of claim 9, wherein the one or more storage devices store instructions that cause the one or more processors to perform operations further comprising:
receiving a second parameter value associated with a second node defined by the content provider of the hierarchy of the account of the content provider associated with the first piece of content; and
receiving a third parameter value associated with a third node defined by the content provider of the hierarchy of the account of the content provider associated with the second piece of content;
wherein generating the first click-through URL for the first piece of content is based on the URL template, the first parameter value, and the second parameter value, and wherein generating the second click-through URL for the second piece of content is based on the URL template, the first parameter value, and the third parameter value.

24. The system of claim 14, wherein the URL template comprises a URL for a traffic analysis service, the one or more storage devices storing instructions that cause the one or more processors to further perform operations comprising:
receiving a second parameter value associated with a second node defined by the content provider of the hierarchy of the account of the content provider associated with the first piece of content, the second parameter value comprising a landing page parameter value;
receiving a third parameter value associated with a third node defined by the content provider of the hierarchy of the account of the content provider associated with the second piece of content, the third parameter value comprising a landing page parameter value;
determining a first landing page URL for the first piece of content based on the landing page URL of the first parameter value and the second parameter value; and
determining a second landing page URL for the second piece of content based on the landing page URL of the first parameter value and the third parameter value.

25. The non-transitory computer-readable storage medium of claim 17, wherein the operations further comprise:
receiving a second parameter value associated with a second node of the hierarchy of the account of the content provider associated with the first piece of content and associated with a second parameter placeholder of the one or more parameter placeholders; and
receiving a third parameter value associated with a third node of the hierarchy of the account of the content provider associated with the second piece of content and associated with the second parameter placeholder of the one or more parameter placeholders;
wherein generating the a first click-through URL for the first piece of content is based on the URL template, the first parameter value, and the second parameter value, and wherein generating the a second click-through URL for the second piece of content is based on the URL template, the first parameter value, and the third parameter value.
